(19) United States
(12) Patent Application Publication
(10) Pub. No.: US 2015/0368110 A1
(43) Pub. Date: Dec. 24, 2015

(54) METHOD OF PREPARING CARBON SHEETS USING GRAPHENE SEED AND CARBON SHEETS PREPARED THEREBY

(71) Applicant: KOREA INSTITUTE OF SCIENCE AND TECHNOLOGY, Seoul (KR)

(72) Inventors: Jae-Kap LEE, Seoul (KR); Yeseul PARK, Seoul (KR); Won-Kook CHOI, Seoul (KR)

(21) Appl. No.: 14/744,230

(22) Filed: Jun. 19, 2015

(30) Foreign Application Priority Data
Jun. 20, 2014 (KR) 10-2014-0076000

(51) Int. Cl. C01B 31/04

(52) U.S. Cl. CPC C01B 31/0453

(57) ABSTRACT

The present disclosure relates to a method of growing a graphene nanopowder having a size of 10 nm or less into a graphene sheet having a seed size or more by using a graphene nanopowder as a seed. Further, in the present disclosure, a graphite sheet in which 2 to 20 layers of the graphene sheet are laminated may be prepared. The carbon sheet (that is, graphene and graphite sheets) may be prepared by preparing a graphene nanopowder (randomly distributed) on a substrate, and then subjecting the substrate to CVD treatment using a gas including a hydrocarbon gas in a chemical deposition apparatus.

### CROSS-REFERENCE TO RELATED APPLICATION

Pursuant to 35 U.S.C. §119(a), this application claims the benefit of earlier filing date and right of priority to Korean Application No. 10-2014-0076000, filed on Jun. 20, 2014, the contents of which is incorporated by reference herein in its entirety.

### BACKGROUND OF THE DISCLOSURE

1. Field of the Disclosure

The present disclosure relates to a carbon sheet including a single layered graphene sheet and a graphite sheet, which may be prepared in a large amount and in a large area, and a preparation method thereof.

2. Background of the Disclosure

Graphene is a basic unit which constitutes a graphitic material and refers to a unit which forms one layer in which carbon atoms constituting a hexagon are two-dimensionally bonded, and the thickness thereof is about 0.4 nm as one layer of carbon atoms.

In order to utilize excellent physical properties of graphene, a large graphene having a size of several nm or more needs to be prepared, but it is very difficult to prepare carbon sheets (or a graphene nanopowder with a side length of several nm or more) in a large amount due to van der Waals forces acting between graphene layers.

When graphene is prepared by a method of detaching graphene from graphite by using cellulose tape, it is impossible to achieve mass production of graphene, and in this case, in the sample, a graphite (that is, a plurality of graphene laminates in which several graphene layers are partially laminated) which may not be considered as graphene is mostly formed.

In order to solve the problem, chemical methods of subjecting graphite to acid treatment have been suggested, but samples to be actually obtained by these methods are also thin graphite (that is, multilayered graphene) having a thickness of 1 to 100 nm, and these methods have a problem in preparing graphene composed of one layer of carbon atoms with a large size.

Further, even in a method of preparing graphene by using a chemical vapor deposition method to grow graphene on a metal or silicon substrate, and then transferring the same on a desired substrate, it was also impossible to prepare graphene having one layer thickness of carbon atoms over a large area of micron size or more.

Meanwhile, the present inventors conceived a method of preparing a large amount of graphene nanopowder by subjecting a helical graphite body to ball-milling [1], but graphene prepared therefrom includes a problem in that there are a large number of defects, and the size thereof is only in a range of several nm because the method also includes mechanical method.

### CITATION LIST

### Patent Document

(Patent Document 1) 1. [1] Korean Patent Publication No. 10-1312104

### SUMMARY OF THE DISCLOSURE

The present disclosure has been made in an effort to prepare a large graphene having a size of several tens of nanometers or more, and an object thereof is to provide a carbon sheet including a single layered graphene sheet having a size of 5 nm to 50 μm and a graphite sheet in which 2 to 20 layers of the single layered graphene sheet are laminated, and a method of preparing the same.

A method of preparing a carbon sheet according to an exemplary embodiment of the present disclosure includes: (a) forming a graphene seed layer in which a graphene nanopowder is randomly distributed on a substrate; and (b) growing the graphene nanopowder included in the graphene seed layer into the carbon sheet by a chemical vapor deposition (CVD) method under a mixed gas including an inert gas and a carbon source gas.

The carbon sheet includes a single layered graphene sheet and a graphite sheet in which 2 to 20 layers of the single layered graphene sheet are laminated, the single layered graphene sheet has a length of 10 mm to 50 μm, and the carbon sheet is formed by the growth of the graphene nanopowder as a seed.

The graphene nanopowder may have a powder particle length of 10 nm or less.

The full width at half maximum of [002] peak for the graphene nanopowder may be 5° or more in an XRD analysis.

Step (a) may form a graphene seed layer by using a suspension in which the graphene nanopowder and an organic solvent are mixed, and the organic solvent may include one selected from the group consisting of alcohol, acetone, dimethylformamide (DMF), and a combination thereof.

The graphene seed layer in step (a) may have a thickness of 10 nm to 100 μm.

The graphene seed layer in step (a) may be formed by performing a method including one selected from the group consisting of spray coating, spin coating, a dispersion method, and a combination thereof.

The chemical vapor deposition method may include a plasma-enhanced chemical vapor deposition (PECVD) method, and the plasma treatment may be performed in a temperature range of 500 to 2,000° C.

A mixed gas pressure of the plasma treatment may be 10 to 1,000 Torr.

The mixed gas may include 51 to 99 vol % of an inert gas and 1 to 50 vol % of a carbon source gas, the inert gas may be one selected from the group consisting of hydrogen, argon, helium, and a combination thereof, and the carbon source gas may be one selected from the group consisting of methane, ethane, acetylene, and a combination thereof.

In step (b), a graphene nanoribbon may be further formed, the graphene nanoribbon may have a thickness of 10 nm or less and a width of 10 nm or less, and a length thereof may be larger than the thickness and the width.

The carbon sheet according to another exemplary embodiment of the present disclosure includes a single layered graphene sheet having a sheet length of 10 nm to 50 μm; and a graphite sheet in which 2 to 20 layers of the single layered graphene sheet are laminated.

The carbon sheet may further include a graphene nanoribbon, the graphene nanoribbon may have a thickness of 10 nm or less and a width of 10 nm or less, and a length thereof may be larger than the thickness and the width.

In the single layered graphene sheet and the graphite sheet, the graphene nanopowder may be a seed, powder particles of the graphene nanopowder may have a length of 10 nm or less, and the full width at half maximum of a [002] peak may be 5° or more in an XRD analysis.

The term “carbon sheet” as used herein, collectively refers to a material formed of carbon, and it is should be understood to mean that the form thereof is not limited to the sheet, and a material in a sheet form among various forms of a final material is predominantly formed, that the term “sheet” is a material which is large in breadth in the form of the material, that is, a material in the shape that has a smaller length than the width or thickness of the material, and that the term “ribbon” is a material which is larger in length in the shape of the material, that is, a material in the shape that has a larger length than the width or thickness of the material.

The present disclosure is intended to provide a carbon sheet and a preparation method thereof, and will be described below in more detail.

A method of preparing a carbon sheet according to an exemplary embodiment of the present disclosure includes: (a) forming a graphene seed layer in which a graphene nanopowder is randomly distributed on a substrate; and (b) growing the graphene nanopowder included in the graphene seed layer to the carbon sheet by a chemical vapor deposition (CVD) method under a mixed gas including an inert gas and a carbon source gas.

The carbon sheet includes a single layered graphene sheet and a graphite sheet in which 2 to 20 layers of the single layered graphene sheet are laminated, a the single layered graphene sheet has a length of 10 nm to 50 μm, and the carbon sheet is formed by the growth of the graphene nanopowder as a seed.

The graphene nanopowder in step (a) may have a powder particle length of 10 nm or less and a thickness of 0.4 nm or less, that is, a thickness of one carbon atom layer. When the graphene nanopowder is in the aforementioned size range, the graphene nanopowder may be randomly distributed in a graphene seed layer to be formed, and the directivity of the graphene nanopowder need not be separately considered, or the graphene nanopowder need not be horizontally or vertically disposed, and the graphene nanopowder may be suitable as a seed to become a nucleus in the growth to the carbon sheet since the graphene nanopower may be uniformly distributed.

The full width at half maximum of a [002] peak for the graphene nanopowder may be 5° or more, preferably 7° or more in an XRD analysis, and may be prepared by grinding a helical crystalline graphite by a mechanical method,

When the full width at half maximum of [002] peak is less than 5°, a single crystalline carbon sheet may not be formed and the graphene nanopowder may be unsuitable as a seed to become a growth nucleus, and a graphene nanopowder, which may be the most suitable as the seed, may be a prepared by grinding the helical crystalline graphite by a mechanical method.

In step (a), the graphene seed layer is formed by using a suspension in which the graphene nanopowder and an organic solvent are mixed, and the organic solvent may be applied without limitation as long as the organic solvent may form the suspension with the graphene nanopowder, and for example, alcohol, acetone, dimethylformamide (DMF), or a mixture thereof, and the like may be used, and the suspension may be usually prepared by using alcohol.

The graphene seed layer may have a thickness of 10 nm to 100 μm. When the graphene seed layer formed on the substrate has a thickness of 10 nm or more and 100 μm or less, the seed layer may be uniform, and it may be easy for the internal graphene nanopowder to be randomly distributed.

Further, the application method may be used without limitation as long as a suspension of the graphene nanopowder can be thinly applied like a black ink by the method when the suspension is applied on the substrate and then the substrate is observed by the unaided eye, and for example, spray coating, spin coating, and the like may be applied.

As the substrate, for example, tungsten, molybdenum, silicon, or copper, and the like may be used. Considering the case where the carbon sheet will be secondarily applied, the substrate may be selected so as to be suitable for the case. Since there is no particular limitation on the selection of the substrate, it is possible to obtain effects of reducing processes, improving an economic efficiency, and the like when the carbon sheet is secondarily applied.

The chemical vapor deposition method in step (b) may include a chemical vapor deposition method using a plasma treatment, and the plasma treatment may be performed in a temperature range of 500 to 2,000° C., preferably 700 to 1,500° C. When the plasma treatment is performed at a temperature of 700 to 1,500° C., the carbon sheet may be smoothly grown without being damaged. However, when the temperature is lower than 500° C., sufficient energy may not be supplied for growing the graphene nanopowder. When the plasma treatment is performed at a temperature higher than 2,000° C., the graphene nanopowder is likely to be melted.

The mixed gas in step (b) may include 51 to 99 vol % of an inert gas and 1 to 50 vol % of a carbon source gas, and when the carbon source gas is more than 50 vol %, the graphene nanopowder is so excessively grown that the graphite in which several ten layers or more of the graphene sheet are laminated may be produced and such graphite is not considered as a graphene any longer.

The inert gas may be applied as long as the gas does not affect growth of the graphene nanopowder, and may be, for example, hydrogen, argon, helium, nitrogen, or a combination thereof, and the like, In addition, the carbon source gas may be used as long as the gas is a hydrocarbon in a gas state, which is capable of supplying carbon so as to grow the graphene nanopowder, and may be, for example, methane, ethane, acetylene, or a combination thereof, and the like, but the types of inert gas and carbon source gas to be applied to the present disclosure are not limited thereto.

The pressure of the mixed gas may be 10 to 1,000 Torr and the flow rate of the mixed gas may be 10 to 1,000 sccm, and preferably, the pressure is 40 to 200 Torr and the flow rate may be 50 to 200 sccm. When the mixed gas has a pressure of 10 to 1,000 Torr and a flow rate of 10 to 1,000 sccm, the supply of a carbon source is suitable, so that it is possible to easily grow the graphene nanopowder to the carbon sheet, and it is possible to prepare a carbon sheet including single layered and graphite sheets, which is not excessively laminated as a desired form, and when the pressure is 40 to 200 Torr and the flow rate is 50 to 200 sccm, the pressure and flow rate may be an optimal condition in growing the graphene nanopowder to the carbon sheet.

The carbon sheet prepared in step (b) may include a single layered graphene sheet and a graphite sheet, the single layered graphene sheet may have a length of several nm to several μm, preferably 10 nm to 50 μm, and the graphite sheet may be a structure in which 2 to 20 layers of the single layered graphene sheet are laminated. Both the single layered graphene sheet and the graphite sheet may be single crystalline.

Furthermore, the carbon sheet may further include a graphene nanoribbon, the graphene nanoribbon may have a thickness of about 10 nm or less, the average thickness thereof may be about 5 nm or less, the width thereof may be about 10 nm or less, and the length thereof may be larger than the thickness and the width.

The carbon sheet according to another exemplary embodiment of the present disclosure includes a single layered graphene sheet having a sheet length of 10 nm to 50 μm; and a graphite sheet in which 2 to 20 layers of the single layered graphene sheet are laminated.

The carbon sheet may further include a graphene nanoribbon, the graphene nanoribbon may have a thickness of 10 nm or less and a width of 5 nm or less, and a length thereof may be larger than the thickness and the width.

The explanation on the carbon sheet, the graphene nanopowder, the single layered graphene sheet, and the graphite sheet, and the like are overlapped as described above, and thus, the description thereof will be omitted.

According to the present invention, the carbon sheet prepared by a chemical vapor deposition method using the graphene nanopowder of the present is disclosure as a seed may be produced in mass and in a large area, and thus, a carbon material in which excellent physical properties of graphene are expressed may be prepared, the applicability of the carbon material as a basic material for electron devices, electrodes of a secondary battery, and flexible electrodes, and as a basic material for a high specific strength/high elasticity composite is provided by a relatively simple method.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1(a) schematically illustrates a method of preparing a carbon sheet according to an exemplary embodiment of the present disclosure,

FIG. 1(b) is a photograph of the carbon sheet prepared according to FIG. 1a, which is taken by HRTEM.

FIG. 1(c) is a partial magnification of FIG. 1(b).

FIGS. 2a and 2b are photographs of the carbon sheet according to an exemplary embodiment of the present disclosure, which is taken by HRTEM.

### DETAILED DESCRIPTION OF THE DISCLOSURE

Description will now be given in detail of the exemplary embodiments, with reference to the accompanying drawings. For the sake of the brief description with reference to the drawings, the same or equivalent components will be provided with the same reference numbers, and a description thereof will not be repeated.

Hereinafter, exemplary embodiments of the present disclosure will be described in detail with reference to the accompanying drawings, such that those skilled in the art to which the present disclosure pertains can easily carry out the present disclosure. However, the present disclosure can be implemented in various different forms, and is not limited to the exemplary embodiments described herein.

### Example 1: Preparation of Carbon Sheet Using PECVD

A graphene nanopowder having a thickness of 0.4 nm or less and an average of width and length of 10 nm, respectively, was prepared by grinding a helical crystalline graphite by a mechanical method [1], and a suspension was prepared by dispersing 1 g of the graphene nanopowder (used as a seed) in 200 ml of ethanol (at this time, the graphene suspension is similar to a black ink). Moreover, a tungsten substrate with a diameter of 100 mm and a thickness of 10 mm was prepared as a substrate, the suspension was sprayed on to the substrate such that the surface thereof may be observed as black, and the suspension was fixed on the substrate by drying.

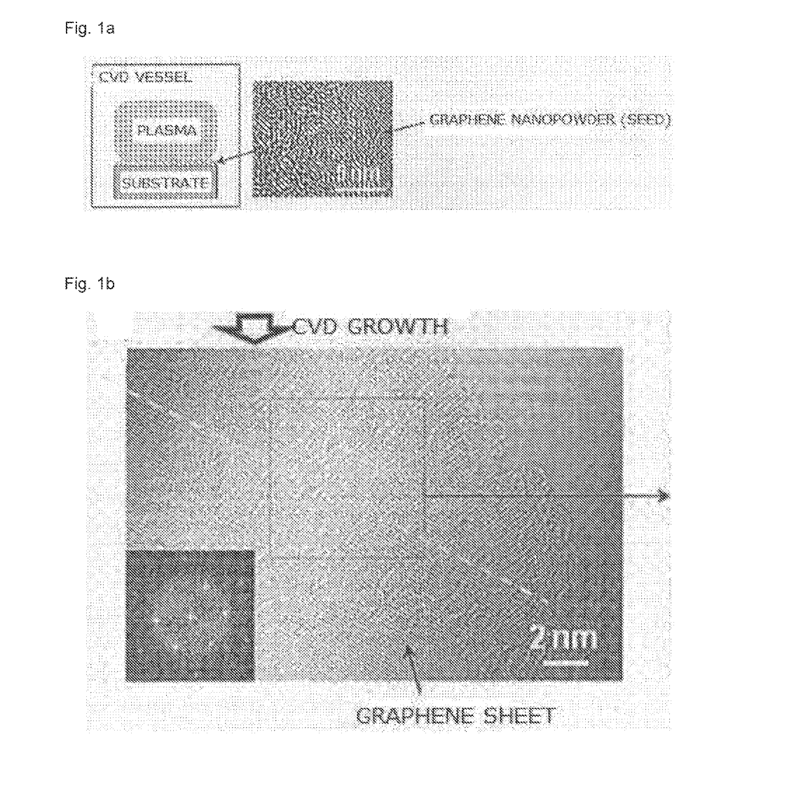

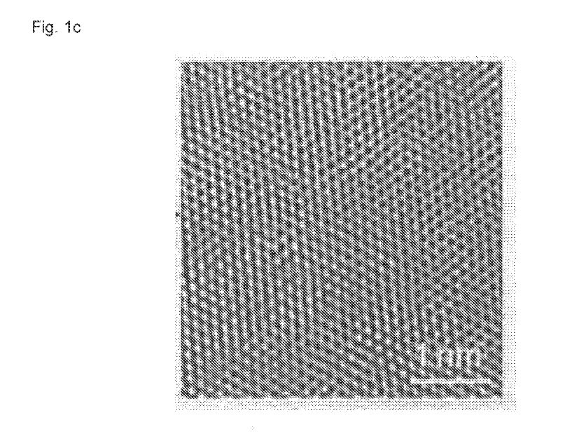

As illustrated in FIG. 1(a), the substrate, on which the graphene nanopowder was sprayed and thus was uniformly distributed, was placed onto a positive electrode site of a plasma-enhanced chemical vapor deposition (PECVD) vacuum chamber, a vacuum atmosphere of approximately 10⁻³ Torr was created in the vacuum chamber, and then a plasma was generated between the negative electrode and the substrate.

The conditions of the plasma treatment were set to a pressure of 100 Torr, a gas flow rate of 200 sccm, a gas composition composed of 10 vol % of CH₄ and 90 vol % of H₂, a substrate temperature of 800° C., and a carbon sheet was prepared by performing the plasma treatment under the conditions for 30 minutes to grow the graphene nanopowder.

FIGS. 1(b) and 1(c) are a photograph of the grown carbon sheet, which is taken by HRTEM and a magnified photograph thereof. Referring to this, it can be confirmed that the carbon sheet was uniformly formed as a single crystal.

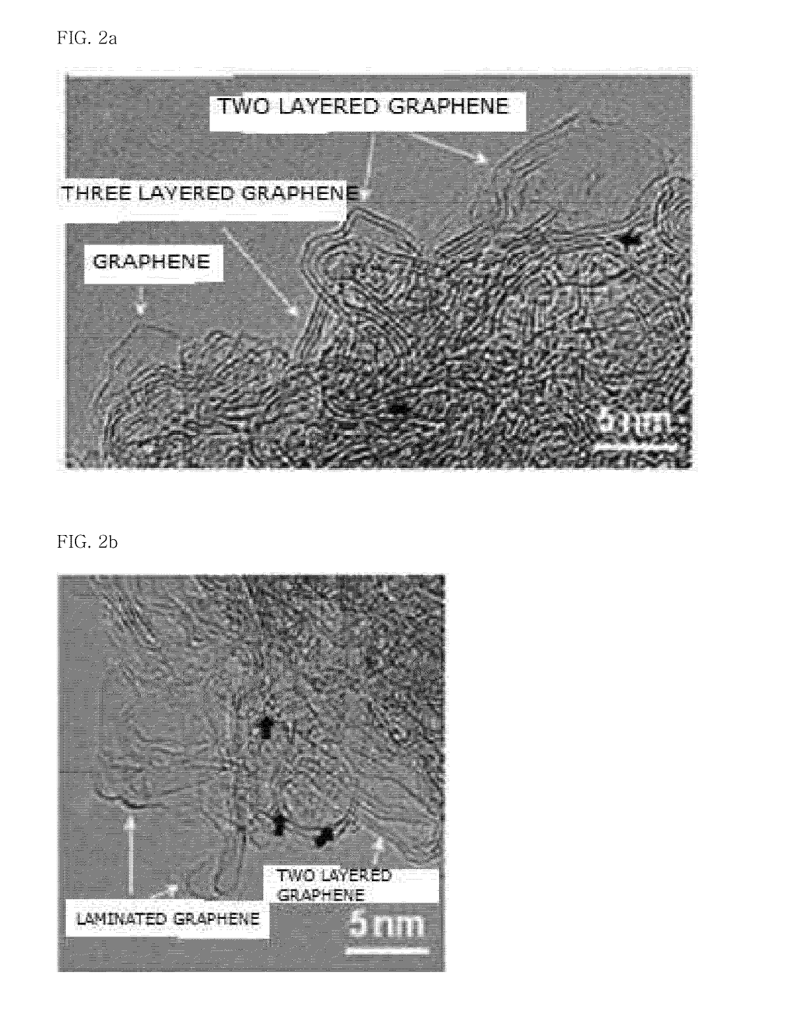

FIG. 2 illustrates photographs of carbon sheets prepared in Example 1, which are taken by HRTEM. Referring to FIG. 2a, the grown carbon sheet (the size is about several hundred nm²) may be observed, and a graphite sheet in which 2 to 5 layers of the graphene sheet are laminated may also be observed together.

FIG. 2b illustrates a structure in which single layered and graphite sheets are laminated. Through this, it can be confirmed that the graphene nanopowder has been grown as a sheet, and that the graphene nanopowder may also be grown as a thin-film type graphite with less layers.

### Example 2: Preparation of Carbon Sheet Using CVD

A carbon sheet was prepared in the same manner as in Example 1, except that a molybdenum substrate having a diameter of 100 mm and a thickness of 10 mm was used as the substrate. CVD was used instead of the plasma treatment to set the conditions to a pressure of 10 Torr a gas flow rate of 200 sccm, a gas composition of 10 vol % of CH₄ and 90 vol % of H₂, and a substrate temperature of 1.000° C., and a growing treatment was performed for 1 hour.

As a result of observing the carbon sheet prepared in Example 2 by HRTEM, it can be confirmed that a graphene sheet similar to the structures shown in FIGS. 1 and 2 and a thin-film type graphite have been produced. Through this, it can be confirmed that the graphene nanopowder used as a seed may be grown more significantly even by a general chemical vapor deposition method in which the plasma treatment has not been performed.

Although preferred examples of the present disclosure have been described in detail hereinabove, the right scope of the present disclosure is not limited thereto, and it should be clearly understood that many variations and modifications of those skilled in the art using the basic concept of the present disclosure, which is defined in the following claims, will also belong to the right scope of the present disclosure.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art, The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A method of preparing a carbon sheet, comprising:
(a) forming a graphene seed layer in which a graphene nanopowder is randomly distributed on a substrate; and
(b) growing the graphene nanopowder comprised in the graphene seed layer into the carbon sheet by a chemical vapor deposition (CVD) method under a mixed gas comprising an inert gas and a carbon source gas,
wherein the carbon sheet comprises a single layered graphene sheet and a graphite sheet in which 2 to 20 layers of the single layered graphene sheet are laminated,
the single layered graphene sheet has a length of 10 nm to 50 μm, and
the carbon sheet is formed by the growth of the graphene nanopowder as a seed.

2. The method of claim 1, wherein the graphene nanopowder has a powder particle length of 10 nm or less.

3. The method of claim 1, wherein a full width at half maximum of a [002] peak for the graphene nanopowder is 5° or more in an XRD analysis.

4. The method of claim 1, wherein step (a) forms a graphene seed layer by using a suspension in which the graphene nanopowder and an organic solvent are mixed, and the organic solvent comprises one selected from the group consisting of alcohol, acetone, dimethylformamide (DMF), and a combination thereof.

5. The method of claim 1, wherein the graphene seed layer in step (a) has a thickness of 10 nm to 100 μm.

6. The method of claim 1, wherein the graphene seed layer in step (a) is formed by performing a method comprising one selected from the group consisting of spray coating, spin coating, a dispersion method, and a combination thereof.

7. The method of claim 1, wherein the chemical vapor deposition method comprises a plasma-enhanced chemical vapor deposition (PECVD) method, and the plasma treatment is performed in a temperature range of 500 to 2,000° C.

8. The method of claim 7, wherein a mixed gas pressure of the plasma treatment is 10 to 1,000 Torr.

9. The method of claim 1, wherein the mixed gas comprises 51 to 99 vol % of an inert gas and 1 to 50 vol % of a carbon source gas, the inert gas is one selected from the group consisting of hydrogen, argon, helium, and a combination thereof, and the carbon source gas is one selected from the group consisting of methane, ethane, acetylene, and a combination thereof.

10. The method of claim 1, wherein in step (b), a graphene nanoribbon is further formed, the graphene nanoribbon has a thickness of 10 nm or less and a width of 10 nm or less, and a length thereof is larger than the thickness and the width.

11. A carbon sheet comprising:
a single layered graphene sheet having a sheet length of 10 nm to 50 μm; and
a graphite sheet in which 2 to 20 layers of the single layered graphene sheet are laminated.

12. The carbon sheet of claim 11, wherein the carbon sheet further comprises a graphene nanoribbon, the graphene nanoribbon has a thickness of 10 nm or less and a width of 10 nm or less, and a length thereof is larger than the thickness and the width.

13. The carbon sheet of claim 11, wherein in the single layered graphene sheet and the graphite sheet is formed by the growth of the graphene nanopowder as a seed, powder particles of the graphene nanopowder have a length of 10 nm or more, and the full width at half maximum of a [002] peak is 5° or more in an XRD analysis.
